(19) United States
(12) Patent Application Publication
(10) Pub. No.: US 2011/0206219 A1
(43) Pub. Date: Aug. 25, 2011

(54) Electronic device for receiving and transmitting audio signals

(76) Inventor: Martin Pamler, Munich (DE)

(21) Appl. No.: 12/807,171

(22) Filed: Aug. 30, 2010

(30) Foreign Application Priority Data
Feb. 23, 2010 (EP) 101 54 415.3

(51) Int. Cl. H04R 3/00

(52) U.S. Cl. 381/92

(57) ABSTRACT

The present invention relates to an electronic device (10) for receiving and transmitting audio signals. In order to provide an electronic device which sufficiently allows filtering out background noise from audio signals and which further allows creating and/or using context information with regard to such background noise, said electronic device (10) comprises a first microphone (11) for detecting audio signals, at least one second microphone (12) for detecting audio signals, a processing unit (13) for receiving said audio signals from the at least two microphones (11, 12), for processing said audio signals and for filtering out background noise from said audio signals and a communication processing unit (14) for transmitting (15) the remaining audio signals to an electronic receiver device (16). Advantageously, said electronic device (10) further comprises an application interface (21) to an application processing unit (20), upon which specific inquiries to the processing unit (13) can be generated.

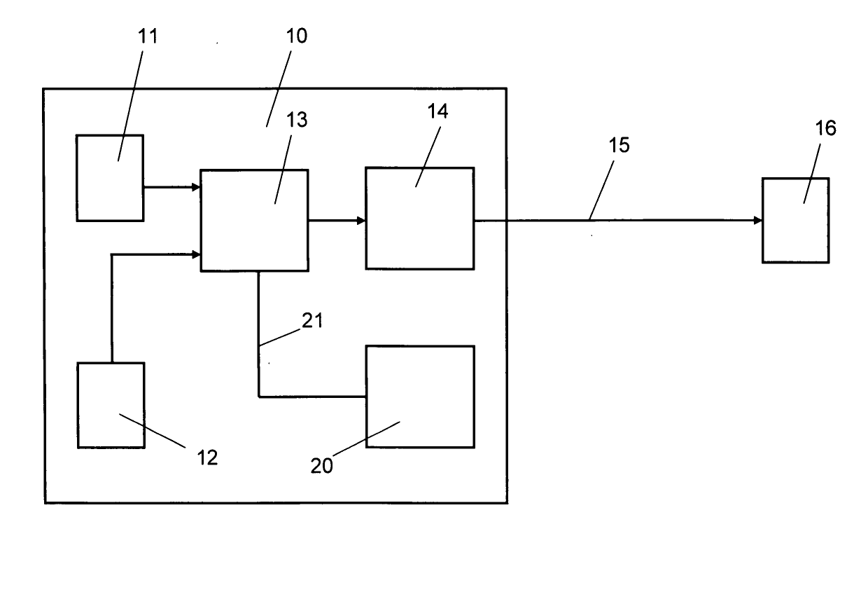

The present invention relates to an electronic device for receiving and transmitting audio signals.

Generally, such devices are well known in the prior art. For example, such electronic devices can be embodied as mobile electronic devices, as mobile phones for examples.

In a typical usage environment of such electronic devices it is not unusual that background noises do exist which badly influence the quality of audio signal transmission. For example, if the user of a mobile phone is located at a place with much background noise and if the user wants to make a phone call to another person, it is often difficult for the callee to understand the caller due to the existing background noise. It is therefore a need to provide solutions that allow eliminating such background noise.

According to a solution existing in general prior art a mobile electronic device, for example a mobile phone, comprises a microphone that detects audio signals such as voice data from the caller as well as background noises. A processing unit within said electronic device processes those incoming audio signals from said microphone and filters out background noises. The remaining audio signals, the voice signals for example, are transmitted to a communication processing unit within said electronic device. From there the remaining audio signals are transmitted to an electronic receiver device, another mobile phone for example.

With regard to the treatment of background noise various suggestions haven been made in the prior art. For example DE 100 49 738 A1 discloses an automatic mute switching system, said system using a microphone incorporated in the housing of a mobile audio device or mobile phone, for detection of background noise. The switching system is coupled to an electronic noise analysis device, comparing the detected noise with stored sound characteristics. Based on the comparison results a switch can be operated for activating or de-activating the mute control for the loudspeakers in the headset of said mobile device.

US 2002/0006207 A1 relates to a method of providing a user with information on the operation of a portable device and to a portable device. In the device, such a tone is produced that, due to a tone feature, can be distinguished from background noise. This feature can be tone frequency, duration, volume or moment of time. The device can analyse background noise automatically, and based on this, it adjusts at least one feature of the tone automatically such that the tone can be distinguished from background noise, and the background noise does not mask out the tone.

However, audio processing requires a lot of processing power due to complex and extensive calculations. Furthermore, there are limits to process audio signals that have been detected by only one single microphone.

It is the object of the present invention to provide an electronic device for receiving and transmitting audio signals, said electronic device allowing overcoming those drawbacks as mentioned before. More particularly, it is the object of the present invention to provide an electronic device which sufficiently allows filtering out background noise from audio signals and which further allows to create and/or use context information with regard to such background noise.

The object is solved by the electronic device comprising those features according to independent claim 1. Additional features and details of the invention are evident from the dependent claims, from the description and from the drawing.

The present invention is based on the finding that it is possible to create context related information with regard to existing background noise. The present invention relates to the usage of such context related information which is derived from a current audio scene representation.

According to the present invention, the object is solved by an electronic device for receiving and transmitting audio signals, said electronic device comprising a first microphone for detecting audio signals, at least one second microphone for detecting audio signals, a processing unit for receiving said audio signals from the at least two microphones, for processing said audio signals and for filtering out background noise from said audio signals and a communication processing unit for transmitting the remaining audio signals to an electronic receiver device.

The present invention is directed to an electronic device, said device being capable of receiving and transmitting audio signals. In any case audio signals which are transmitted by said electronic device shall comprise background noise. In particular, a background noise is any sound other than the sound being typical in the field of application of the electronic device. Background noise can be a form of noise pollution or interference. Examples of background noises are environmental noises such as traffic noise, alarms, people talking, noise from animals, mechanical noise from machines, and the like.

Examples of preferred embodiments of such electronic devices, which however do not limit the scope of the present invention, are described in the following. For example, the electronic device is a mobile electronic device, preferably a mobile phone, a personal digital assistant, a smart phone or the like. In case of a mobile phone the audio signals preferably comprise voice signals as well as background noise.

According to the present invention a first microphone is provided said microphone being adapted for detecting audio signals. Additionally, at least one second microphone for detecting audio signals is provided. However, the present invention is not limited to a specific number of microphones which are arranged within said electronic device.

Those microphones detect audio signals from the outside of the electronic device. In case of a mobile phone such audio signals can comprise voice signals, which origin from the user of the mobile device as well as background noise, which origins from the environment the user of the mobile device is located at.

Furthermore, the electronic device according to the present invention comprises a processing unit for receiving said audio signals from the at least two microphones. The processing unit is adapted for processing the audio signals. In particular the processing unit is adapted for filtering out background noise from said audio signals. In other words, the processing unit, which can be embodied as a chip for example, processes those incoming audio signals from said microphones and filters out background noises. Therefore, only such audio signals which are typical in the field of application of the electronic device—voice signals in the field of mobile phones for example—are further transmitted by said electronic device.

Those audio signals, which have been separated from said background noise, are transmitted to a communication processing unit for transmitting the remaining audio signals, said communication processing unit being part of the electronic device as well. For example the communication processing unit can be formed as a Communication-CPU (CCPU—C-Central Processing Unit)

From there, the filtered audio signals, for example voice signals, are transmitted, for example by use of radio transmittance in case of a mobile phone, to an electronic receiver device. Examples of preferred embodiments of such electronic receiver devices, which however do not limit the scope of the present invention, are described in the following. For example, the electronic receiver device is a mobile electronic device, preferably a mobile phone, a personal digital assistant, a smart phone or the like.

According to the present invention the electronic device comprises at least two microphones which detect audio signals and which transfer said audio signals to a processing unit. Within said processing unit those audio signals are processed by filtering out background noises. The remaining parts of said audio signals, voice signals for example, art transmitted to a remote electronic receiver device. However, the present invention further enables such electronic devices to create and/or use context information which is derived from the current audio scene representation and which can enable new services on top of it.

Preferably, the at least two microphones are arranged as a microphone array. For example, a microphone array is any number of microphones operating in tandem that means in an arrangement, wherein one microphone is placed behind another. In particular, an array can consist of unidirectional microphones distributed about the perimeter of a space, said microphones being linked to the processing unit that records and interprets the results into a predetermined form. Arrays may also be formed using numbers of very closely spaced microphones. However, the present invention is not limited to this specific embodiment.

According to a preferred embodiment of the present invention the processing unit for receiving and processing said audio signals comprises means for analysing the filtered out background noise. Thus, it is possible to generate context information with regard to the background noises.

Advantageously, the electronic device comprises a storage unit for storing said filtered out background noise and/or for storing any generated context information with regard to the background noises. Alternatively or in addition the electronic device can comprise an interface to an external storage unit for storing said filtered out background noise.

According to a preferred embodiment the communication processing unit comprises a baseband or the communication processing unit is formed as a baseband. In particular, a baseband describes a telecommunication system in which information is carried in digital form on a single non-multiplexed signal channel on the transmission medium.

Advantageously, the processing unit for receiving and processing said audio signals comprises an application interface to an application processing unit. For example, the application processing unit can be formed as an application central processing unit (Application-CPU). In such a case, the electronic device according to the present invention provides an extended Interface to the processing unit for receiving and processing said audio signals. Via said application interface it is possible to create extended inquiries with regard to the audio signals and particularly to those background noises that have been detected by said microphones. For that reason, the application interface is preferably linked to an application processing unit which is described in greater detail further below. Preferably, said application interface is formed as an intelligent interface.

Advantageously, the application interface comprises a data channel.

According to a preferred embodiment of the present invention the electronic device comprises an application processing unit. This processing unit can be formed as an additional central processing unit (CPU). Via said application processing unit and said application interface it is possible for a service to provide said processing unit for receiving and processing said audio signals with specific inquiries.

With regard to said processing unit for receiving and processing said audio signals the application interface provides an extended interface. Via said extended interface it is possible to provide said processing unit for receiving and processing said audio signals with specific inquiries. For example, such inquiries can be generated within or by use of said application processing unit. Those inquiries are transmitted via said application interface, a data channel for example, from said application processing unit to said processing unit for receiving and processing said audio signals. For example, it is now possible to determine within said processing unit for receiving and processing said audio signals, where the noise source is located, what kind of noise source the incoming background noises origin from and the like.

Preferably, the processing unit for receiving and processing said audio signals and/or the application processing unit is formed as a digital signal processor (DSP). In particular, a digital signal processor is a special-purpose CPU (Central Processing Unit) that provides ultra-fast instruction sequences. Generally, digital signal processing is a technique that converts signals from real world sources—usually in analogue format—into digital data that can be further processed. The extension of such DSP solutions with such an application interface allows getting audio context information.

According to the present invention the electronic device now is capable of removing background noise from audio data, for example from a voice call, so that the called side, the callee, will her the calling side, the caller, clearly and without any background noise. In contrast to stationary background noise a huge amount of processing power is required with regard to non-stationary background noise, in order to perform such calculations in real time. By adding at least one second microphone to the electronic device, sufficient information is available to separate the speaker(s) from the background noise thus that a clear voice can be transmitted.

By use of the processing unit for receiving and processing said audio signals as well as the at least two microphones the electronic device is enabled to calculate a three-dimensional representation of the environment in real time. For example the processing unit calculates the location of a sound source relatively to the electronic device. The electronic device can generate a fingerprint of the environment based on the background sounds, and/or it can calculate the voice characteristics.

According to a preferred embodiment, the processing unit for receiving and processing said audio signals of the electronic device and/or the application processing unit comprises means for creating context related information based on the filtered out background noise. Preferably, the electronic device comprises display means for displaying said context related information.

The technology as implemented within the electronic device according to the present invention enables mobile devices to provide a number of useful services to the user. For example, it can act as a “third ear” for deaf people. In such a case, the electronic device can support the user with visual information of the environment. For example, the electronic device can create a warning, for example that a car is passing fast from the side that someone is knocking on the door or the like. Through fingerprinting, applications get capable of reacting on the environment, e.g. if someone is near a river, within a traffic jam, in the woods, or the like. And with other voice characteristic information like male/female, angry/in good mood or the like, further personalised applications become accessible.

The present invention relates to an electronic device for receiving and transmitting audio signals. In order to provide an electronic device which sufficiently allows filtering out background noise from audio signals and which further allows creating and/or using context information with regard to such background noise, said electronic device comprises a first microphone for detecting audio signals, at least one second microphone for detecting audio signals, a processing unit for receiving said audio signals from the at least two microphones, for processing said audio signals and for filtering out background noise from said audio signals and a communication processing unit for transmitting the remaining audio signals to an electronic receiver device. Advantageously, the electronic device further comprises an application interface to an application processing unit, upon which specific inquiries to the processing unit for receiving and processing said audio signals can be generated.

For a better understanding of the present invention an electronic device for receiving and transmitting audio signals, embodying the present invention, will now be described by way of example, with reference to the accompanying drawing which shows schematically the components of the electronic device.

In accordance with the embodiment, the mobile device 10, which is a mobile phone, comprises at least two microphones 11, 12, which are arranged as array microphones. A processing unit 13 for receiving and processing audio signals in form of a Digital Signal Processor (DSP) processes those incoming signals from microphones 11, 12 and filters out background noises. The remaining voice signals are transmitted to a communication processing unit 14, a Communication-CPU (CCPU) for example, which is advantageously formed as a baseband. From there the remaining audio signals, the voice signals for example, are transmitted by use of radio transmittance 15 to an electronic receiver device 16.

The electronic device 10 according to the present invention comprises an additional application processing unit 20, an Application CPU.

Furthermore, the electronic device 10 according to the present invention comprises an intelligent application interface (API) 21. Thus, the electronic device 10 according to the present invention provides an extended interface, API 21 to processing unit 13. Said interface 20 can be formed as a data channel. Via said application interface 21 it is possible to create extended inquiries with regard to the signals that have been received by microphones 11, 12. For that reason, API 21 is preferably linked to the additional application processing unit 20.

Via said API 21, a service can provide processing unit 13 with specific inquiries. For example, it is now possible to determine within processing unit 13, where the noise source is located, what kind of noise source the incoming background noises origin from and the like.

In addition to existing prior art solutions where it is solely possible to filter out background noises in order to enhance the quality of incoming voice data, it is the goal of the present invention to provide a solution, by use of which it is possible to create context related information with regard to the background noises.

### LIST OF REFERENCE NUMERALS

10 Electronic device
11 Microphone
12 Microphone
13 Processing Unit for receiving and processing audio signals
14 Communication Processing Unit
15 Transmission of audio signals
16 Electronic receiver device
20 Application processing unit
21 Application interface

1. An electronic device for receiving and transmitting audio signals, said electronic device comprising a first microphone for detecting audio signals, at least one second microphone for detecting audio signals, a processing unit for receiving said audio signals from the at least two microphones, for processing said audio signals and for filtering out background noise from said audio signals and a communication processing unit for transmitting the remaining audio signals to an electronic receiver device.

2. The electronic device according to claim 1, characterized in that the electronic devices is a mobile electronic device, preferably a mobile phone.

3. The electronic device according to claim 1, characterized in that the at least two microphones are arranged as a microphone array.

4. The electronic device according to claim 1, characterized in that the processing unit for receiving and processing said audio signals comprises means for analysing the filtered out background noise.

5. The electronic device according to claim 1, characterized in that the electronic device comprises a storage unit for storing said filtered out background noise and/or an interface to an external storage unit for storing said filtered out background noise.

6. The electronic device according to claim 1, characterized in that the communication processing unit comprises a baseband or that the communication processing unit is a baseband.

7. The electronic device according to claim 1, characterized in that the processing unit for receiving and processing said audio signals comprises an application interface to an application processing unit.

8. The electronic device according to claim 7, characterized in that the application interface comprises a data channel.

9. The electronic device according to claim 7, characterized in that the electronic device comprises an application processing unit.

10. The electronic device according to claim 1, characterized in that the processing unit for receiving and processing said audio signals and/or the application processing unit is a digital signal processor.

11. The electronic device according to claim 1, characterized in that the processing unit for receiving and processing said audio signals and/or the application processing unit comprises means for generating context related information based on the filtered out background noise.

12. The electronic device according to claim 11, characterized in that the electronic device comprises display means for displaying said context related information.
